(19) United States
(12) Patent Application Publication
(10) Pub. No.: US 2026/0166662 A1
(43) Pub. Date: Jun. 18, 2026

(54) BLADE REPAIR METHOD OF AN INTEGRALLY BLADED ROTOR

(71) Applicant: GKN AEROSPACE SWEDEN AB, Trollhättan (SE)

(72) Inventors: Dzevad Imamovic, Trollhättan (SE); Jimmy Johansson, Trollhättan (SE); Krister Dahl, Trollhättan (SE); Stefan Karlsson, Trollhättan (SE); Andreas Segerstark, Trollhättan (SE)

(21) Appl. No.: 19/127,101

(22) PCT Filed: Oct. 23, 2023
(86) PCT No.: PCT/EP2023/079460

§ 371 Date: May 2, 2025

(30) Foreign Application Priority Data
Nov. 4, 2022 (GB) 2216469.3

(51) Int. Cl. B23P 6/00

(52) U.S. Cl. CPC B23P 6/00

(57) ABSTRACT

The invention concerns a method of turbine blade repair in which a damaged region (Di) is machined away (Rz) and repaired with a directed energy deposition process before being machined to a desired and predetermined aerodynamic profile.

### BACKGROUND

The present invention is concerned with an improved blade maintenance approach or method for gas turbine blades. Specifically, but not exclusively, the method allows for the repair of turbine blades of the types used more and more commonly in high performance gas turbine aircraft engines.

Gas turbine engine blades operate at both high rotational speed and high temperatures. Although modern manufacturing techniques allow for high quality materials to be used with precision engineering surfaces the working environment of such turbines does mean that damage, over time, can occur. This may be because of fatigue, internal damage or inclusions in the material or even strike damage from debris entering an engine and colliding with one or more blades. It is therefore necessary to provide a means to repair engines which have sustained such damage or which have developed defective or dangerous blades.

A common approach to allow for engine blade maintenance is to form rotors (assemblies comprising many blades), for example, with a plurality of removable blades, each blade radially extending from a central hub. If a blade is damaged, as described above, it can be removed and replaced. This allows for continued use of such engines through engine blade repair.

However, there is a desire to decrease the number of components forming an engine and so modern engines also use rotors having integrated blades i.e. a single component integrating the central rotor with the radially extending blades. Advantageously this reduces the number of components but requires a complex single component. Such rotors having integrated blades are known in the art as IBRs (integrated blade rotors) or alternatively ‘Blisks’.

Blisks (Integrally Bladed Rotors) generally have better aerodynamics and efficiency than conventional rotors with individual removable blades but any damage of IBR blades requires substantial work to disassemble the engine for maintenance so that the rotor may be replaced. This is a large maintenance task with associated costs and has discouraged some operators and manufacturers from using Blisk technology even with its efficiency improvements in operation.

The difficulties of using Blisk technology in rotor manufacture is further compounded by the dimensions of some of the aerodynamic profiles forming the blades, particularly at the blade tip regions where repair is difficult to achieve due to the reduced thickness of the tip geometry.

The present inventors have devised an alternative repair method and approach that allows Blisk technology to be more readily used in engine design thus allowing engine manufacturers to achieve greater engine efficiencies and performance without unduly increasing the repair and maintenance of blades should they become damaged or fatigued and require repair.

The inventions described herein may be applied to gas turbine engine components such as compressor blades or turbine blades and may also be used in power generators using blade technologies such as electrical generators.

### SUMMARY OF THE INVENTION

Aspects of the invention are set out in the accompanying claims.

Viewed from a first aspect of an invention described herein, there is provided a method of fan blade repair, the fan blade comprising a repair region and a predetermined repaired geometry, the method comprising the steps of:
aligning a fan blade repair patch against a pre-machined away portion of the fan blade defining a repair perimeter, wherein a portion of the perimeter of the fan blade repair patch has a geometry generally complementary in shape to the repair perimeter of the fan blade so as to define a joining zone between the fan blade and repair patch; and
depositing material by means of direct energy deposition into the joining zone to join the fan blade and repair patch.

The fan blade may be a compressor blade for a gas turbine engine or a fan blade for the same. The method described herein may equally be applied to gas turbine guide vanes or blades or fan blades used in turbines for electrical generation or turbines used in nuclear applications such as power generation or propulsion.

The deposition process itself may be both a wire deposition technique or a powder deposition technique. Other deposition techniques may also be used.

According to a method described herein a damaged blade may be conveniently repaired and restored to a state in which aerodynamic properties and structural integrity are restored. The significant cost of replacing a damaged blade with an entirely new blade is substantial and consequently a method described herein improves the longevity and operations costs of engines or generators comprising damaged blades.

The damage may be visible or may be identified by suitable non-destructive testing (NDT) which may identify cracks or fissures compromising the integrity of the blade. The damaged area may advantageously be machined away using suitable machining equipment such as CNC milling machinery or the like. Thus, the integrity of the remainder of the blade can be retained and only the damaged area or region machined away. The surfaces of the machined away area may be treated with acid and/or etched in advance of the welding process described herein.

The machined away area or region defines a repair perimeter of the fan blade.

According to one embodiment described herein a repair patch is provided which is used to restore the geometry of the blade. Once the repair patch has been welded or joined to the blade to be repaired a portion of the repair patch (now connected to the blade) may be machined away (together with any excess material) to recreate the predetermined geometrical shape of the turbine blade.

Advantageously the repair patch may have dimensions that extend beyond the desired outer dimensions of the repaired blade to the geometry to be recreated. In effect the repair patch may be deliberately selected to be larger than the desired profile of blade to allow the material to be machined away to the desired final geometry.

Similarly the area of deposited material forming the connection between the repair patch and blade may be formed so as to extend beyond the geometry of the desired final blade profile. Firstly, this allows the process to stabilise before the critical repair area is formed. Again, this also allows the material to be machined back to provide an accurate correspondence between the original blade and the repaired area.

The step of depositing material by means of direct energy deposition to join the blade and repair patch may advantageously comprise the steps of (a) forming a weld bead to join the blade and patch together and (b) repeatedly forming subsequent weld beads to fill the joining zone with material.

The angle between the machined blade to be repaired and the perimeter of the repair patch may be any suitable angle. Advantageously the joining zone may be in the form of a generally V-shaped region between the repair patch and repair perimeter of the blade. Thus, successive weld beads can be built to fill in the V-shaped profile. Advantageously the angle between the machined repair patch and blade may be between 30 and 50 degrees and more advantageously 45 degrees.

In order to avoid any stress raising geometries in the connection between the blade and the repair patch both the machined blade and machined repair patch may be in the form of one or more curves or straight and curved profiles. The deposited beads of material may then conveniently follow the smooth curved profile.

In another embodiment the blade repair patch may have a connecting region and a region corresponding in shape to the original blade. Thus, machining of the repaired blade may be limited to only machining the area of connection between the repair patch and blade i.e. machining excess deposited material.

As described herein, the repair patch may have a shape such that when brought into abutment with the machined perimeter of the blade to be repaired a V-shaped region is defined which may be filled with deposited material.

Alternatively, the repair patch may be in the form of a surface or substrate onto which material may be deposited to recreate the damaged and removed (machined away) blade area or region. In such an arrangement the repair patch is in abutment with one side of the turbine blade and defines a substrate area onto which the material may be deposited. The blade may be machined to include a 45 degree (or other) angled perimeter as described above. In such an embodiment the repair zone is actually the entire machined away region i.e. the deposition steps are repeated across the substrate to recreate or rebuild material on the substrate.

In order to create a uniform and consistent deposition (weld) bead the step of deposition may advantageously be commenced or started at a position outside of the geometry of the desired repaired blade. My commencing deposition at a start and stop position outside of the geometry of the desired blade the integrity of the deposited material can be maintained and any discontinuities associated with starting and stopping deposition of material or laser heating can be avoided. Thus, in such an arrangement, wherein when the repair patch is in abutment with the repair perimeter of the blade at least one of the dimensions of the patch extends beyond the dimension of the desired repaired geometry of the blade.

In another arrangement, all dimensions of the repair patch in an x, y and z plane may extend beyond the dimension of the desired repaired geometry of the blade and the method may comprise the step of machining those dimensions of the joined blade and patch to recreate the predetermined blade geometry. Advantageously each deposition step may then commence and terminate on a portion of the repair patch outside of the dimensions of the predetermined repaired geometry.

The repair methods described herein may be used with a variety of deposition additive manufacturing process including, but not limited to, laser blown material deposition or laser wire deposition.

A method may additionally and optionally include the step of machining and acid etching the edges of the repair patch which are to be welded. This avoids the formation of alpha phase material which is undesirable.

Advantageously the methods described herein may additionally involve heat treating the machined and repaired blade. This may be localised heat treatment of the repaired area of blade or heat treatment of the entire blade by means of an oven or autoclave.

The methods described herein may also comprise one or more steps of cooling all or part of the repair patch during the step of material deposition. In doing so a fine microstructure of material can be achieved which has improved metallurgical and mechanical properties.

Viewed from another aspect there is provided a method of blown powder laser metal deposition or laser wire metal deposition blade repair, the blade comprising a repair region and a predetermined repaired geometry, the method comprising the steps of:
machining away a portion of the turbine blade, the portion incorporating the repair region wherein the machined portion defines a repair perimeter of the blade;
aligning a blade repair patch against or proximate to the machined away portion, wherein a portion of the perimeter of the blade repair patch has a geometry generally complementary in shape to the repair perimeter of the blade so as to define a joining zone between the blade and repair patch; and
performing blown powder or wire laser metal deposition within the joining zone to join the turbine blade and repair patch.

Viewed from a still further aspect, there is provided a method of fan blade repair, the fan blade comprising a repair region and a predetermined repaired geometry, the method comprising the steps of:
aligning a fan blade repair patch against a pre-machined away portion of the fan blade defining a repair perimeter, wherein a portion of the perimeter of the fan blade repair patch has a geometry generally complementary in shape to a portion of the outer geometry of the fan blade to the repair so as to define substrate zone to receive deposited material; and
depositing material by means of direct energy deposition into the substrate zone to join the fan blade and repair patch and recreate a volume of material forming the repaired blade.

Viewed from yet another aspect there is provided a computer numerically controlled robotic arm comprising a deposition apparatus configured to perform a method according to a method described herein.

### DRAWINGS

Aspects of the invention will now be described, by way of example only, with reference to the accompanying figures in which:

FIGS. 1A to 1J illustrate the steps of a first embodiment of a method described herein;

FIG. 1K illustrates a cross-section of a repaired blade according to a method described herein;

FIGS. 2A to 2D illustrate a repair patch according to a method described herein;

FIGS. 3A to 3D show a repair patch and cross-section through the repair patch and additionally weld beads formed between the blade and patch;

FIGS. 4A to 4D illustrate a repaired blade with repair patch before machining;

FIG. 5A to 5I illustrate an alternative repair method described herein;

FIG. 5J illustrates a cross-section of a repaired blade according to a method described herein; and

FIGS. 6A to 6D and 6A′ to 6D′ illustrate the second method and substrate patch in plan and cross-section before and after deposition.

While the invention is susceptible to various modifications and alternative forms, specific embodiments are shown by way of example in the drawings and are herein described in detail. It should be understood however that the drawings and detailed description attached hereto are not intended to limit the invention to the particular form disclosed but rather the intention is to cover all modifications, equivalents and alternatives falling within the spirit and scope of the claimed invention.

Any reference to prior art documents in this specification is not to be considered an admission that such prior art is widely known or forms part of the common general knowledge in the field. As used in this specification, the words “comprises”, “comprising”, and similar words, are not to be interpreted in an exclusive or exhaustive sense. In other words, they are intended to mean “including, but not limited to”. The invention is further described with reference to the following examples. It will be appreciated that the invention as claimed is not intended to be limited in any way by these examples. It will also be recognised that the invention covers not only individual embodiments but also combination of the embodiments described herein.

The various embodiments described herein are presented only to assist in understanding and teaching the claimed features. These embodiments are provided as a representative sample of embodiments only and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the spirit and scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

It will be recognised that the features of the aspects of the invention(s) described herein can conveniently and interchangeably be used in any suitable combination

### DETAILED DESCRIPTION

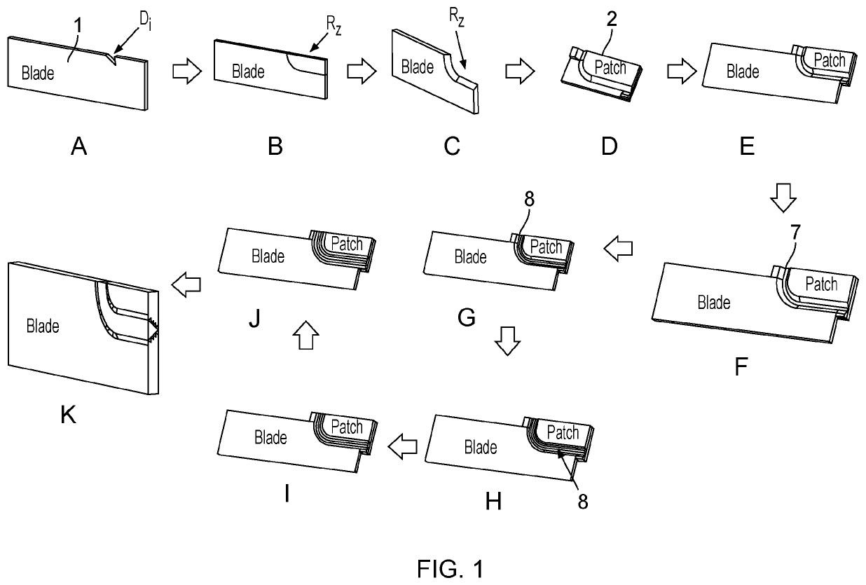

FIGS. 1A to 1K illustrate steps of a first embodiment of a method of turbine blade repair described herein. The blade illustrated has a simplified geometry but it will be appreciated that a turbine blade has a complex curved and aerodynamic profile/shape not illustrated in the present figures.

The Blade 1 in FIG. 1A comprises a discontinuity Di i.e. damage that requires repair in order for the blade to be safely used and to maintain aerodynamic characteristics and performance. It will be recognised that the blade 1 shown in FIG. 1A is one of a plurality of blades that extend radially from a central hub.

The discontinuity Dᵢ may be caused by fatigue, erosion, a strike damage or as a result of other operational conditions or events. As described above, in conventional arrangements with removable blade this single blade would be removed and replaced. In an integrated blade arrangement then conventionally the entire rotor would require replacement i.e. including blades that are not in fact damaged.

FIG. 1B illustrates the repair zone or region Rz which represents an area of the blade which is larger than the discontinuity Dᵢ or damaged area. The first step of a repair method described herein involves machining away the repair zone/portion of the blade i.e. machining away a portion of the blade sufficiently large in area to remove the discontinuity Dᵢ or damaged area of the blade.

The repair zone or portion may be machined away using any suitable machining operation such as a robotic milling machine for example. As shown the repair zone or portion is machined so as to not only remove the discontinuity Dᵢ but also to define a smooth curved portion which advantageously removes any stress raising geometries in the repair. As shown a radius is provided as shown in FIG. 1B.

FIG. 1C also illustrates an additional feature of the repair zone Rz and specifically a tapered geometry to the edge of the zone. The tapered geometry cooperates with the repair patch geometry (described below) to define a region in which repair material may be deposited and which allows for a strong and reliable connection between repair patch and blade.

The angle of the taper may be any suitable angle. However, an angle of 45 degrees allows for convenient access for welding whilst minimising the weld material that is needed to connect the patch to the blade or to re-build the blade surface on a backing plate.

Advantageously an invention described herein includes a repair system comprising a plurality of repair patches, each patch having a different size and being usable to repair damage of differing sizes. For example a deep and narrow fissure or damaged portion of the blade may require a long and narrow repair patch. Conversely damage to the blade which is limited to the surface of the blade may require a longer but less deep repair patch. Thus, a suitable patch size may be selected for the repair and a corresponding region of blade machined away to remove the damage.

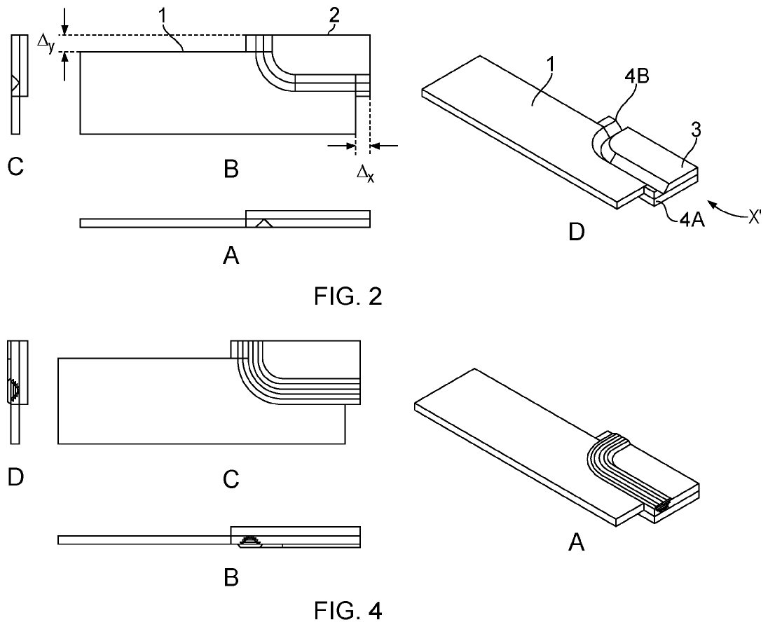

FIG. 1D shows the repair patch according to one embodiment of repair method described herein. The repair patch 2 is shown in more detail in FIGS. 2A to 2D in which the repair patch 2 is in abutment with the blade 1. As shown the repair zone or portion has been machined and comprises the curved geometry described above.

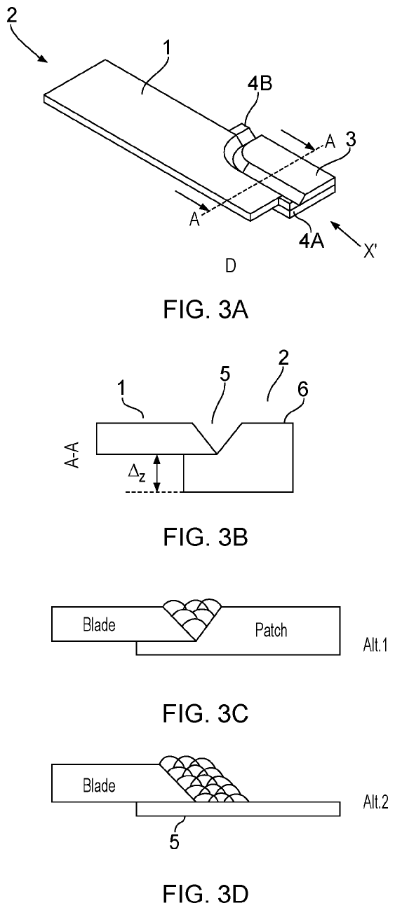

As shown the repair patch 2 comprises a first region 3 which may correspond to the desired geometry of the repaired blade. Alternatively it may have a geometry that allows the repaired geometry to be recreated by machining of the region 3 i.e. the region has dimension that are greater than the desired geometry to allow the region to be machined to the desired geometry. As shown the repair patch 2 has two optional abutment stops 4A and 4B which abut with the edges of the blade to allow the patch to be brought into close contact with the blade before the two are connected together to create the repaired blade. FIG. 3B shows an end view of the edge of the repair patch in abutment with the blade (see X1 in FIG. 2D). As illustrated a deposition zone 5 is provided in a generally V shaped profile between the repair patch 2 and the blade 1. Wedge shaped abutment stops 4A and 4B allow the patch to be firmly located against the blade for the deposition process (as described below).

FIGS. 2A, 2B and 2C show side and plans views of the repair patch and blade before material deposition into the zone 5 has taken place. It will be recognised that the abutment stops 4A and 4B securely locate the repair patch into precisely the position required.

FIG. 3A shows the repair patch and blade before welding. FIG. 3B shows a cross-section through section A-A′ in FIG. 3A. FIGS. 3C and 3D show examples of how weld beads are built up between the blade and patch.

As also shown in FIG. 2A to 2D and FIG. 3B the repair patch has geometries in the x, y and z directions that extend beyond the original geometries of the blade 1. These are illustrated by dimensions Δx, Δy and Δz.

The extended geometries Δx, Δy and Δz are important in the repair process since they allow the repair patch to provide a material deposition zone 5 that begins and terminates outside of the normal geometric boundaries of the blade. Specifically, because the geometries Δx, Δy and Δz are greater than the desired geometry (that is the aerodynamic outer profile) of the blade once repaired a number of technical advantages can be realised according to a method described herein:

Firstly, the excess material allows for machining to take place to restore the original blade geometry. The excess material provided for by the patch allows the precise geometry to be formed.

Secondly, by providing an ‘over-sized’ repair patch with geometries extending beyond the blade in the x and y axes a deposition path or zone 5 is provided that can commence and terminate outside of the normal boundaries or edges of the blade. This provides continuity advantages which are described further below.

During welding the repair patch may be suitably clamped to the surrounding blade to ensure continuity of weld, repair patch and blade.

Additionally, the upper surface 6 (shown in FIG. 3B) of the repair patch may already comply with the desired geometry of the repaired blade thus reducing the required machining only to the other geometries of the blade.

FIG. 3C shows how the zone 5 can be rebuilt or ‘filled in’ using repeating weld beads as shown. The excess of the convex beads extending from the surface 6 after welding can be machined away to the desired profile.

FIG. 4D shows an alternative repair in which a thinner substrate layer is used and onto which weld beads can be progressively laid. In this example the patch may be redundant and the entire replace created using weld beads. Again, excess material including the substrate can be machined away to the desired profile.

An invention described herein has particularly advantageously applications in aircraft engine design and operation in both fixed wing aircraft but also rotary wing aircraft such as helicopters and the like.

The deposition steps will now be described with reference to FIGS. 1A to 1H.

As described above the repair patch is brought into contact with the blade 1 as shown for example in FIG. 1E. Next, a first deposition step is performed in which a first connecting bead 7 is deposited at the base of the generally V shaped region 5 shown in FIG. 1F. This connecting bead couples the patch and the blade together.

The deposition process involves depositing blown powder towards a laser beam which causes the powder to melt and to form a weld pool. The laser beam and powder are simultaneously moved to create a weld bead which cools as the laser moves along the bead. Advantageously the process described herein provides a repair process that involves less heat being created in the blade and repair material. Specifically, the powder is fed into a melt-pool that is created on a substrate material by the laser. The powder is melted both by the laser and by entering the molten substrate material. Most of the cooling comes from conduction of the surrounding un-melted substrate material and previous deposited material. However, some cooling comes from the surrounding gas environment (convection) and some are radiated away. This advantageously reduces the effects of high temperatures on the blade.

Conventional robotically controlled laser beam welding machines may be used and will be understood by a person skilled in the art of additive manufacture. A typical and suitable laser source is a TruDisk 5001 manufactured by Trumpf.

Importantly, as shown the deposition bead commences outside of the geometry of the blade i.e. within the Δx, Δy regions shown in FIG. 1F, FIG. 2 and FIG. 4. This advantageously means that as the deposition process commencing the temperature and material flow/melting is in a steady and stabilised state as the material is deposited to form the repair blade area. By avoiding deposition start and stop within the repair portion or area discontinuities and deposition inclusions can be avoided thereby creating a high quality deposited material within the repair zone or portion.

The start and stop positions also allow the deposition bead(s) to be precisely controlled in terms of position with respect to one another in each dimension.

Referring to FIGS. 1G and 1H the next stage of the method involves further deposition taking place as shown by further deposition beads 8.

Referring now to FIGS. 1I and 1J the process is repeated until the deposition zone 5 has been completely filled with material. As illustrated in FIG. 1J the deposition beads continue so as to exceed the upper surface of the desired blade geometry. The resulting blade (after the deposition steps) has a repair zone with geometries that exceed the desired final blade aerodynamic profile. In effect the desired and predetermined aerodynamic shape of the repaired blade is contained within the volume of material formed by the deposition process. Importantly, because of the way in which deposition is commenced and terminated outside of those desired geometries the quality, uniformity and therefore reliability of the resulting repaired component (here a blade) can be optimised.

The final blade geometry can be created by machining away the excess material which has been deposited around the predetermined and desired geometry of the repaired blade. This may be performed by any suitable milling or machining operations but may advantageously be performed by a multi-axis robotic machine head to allow complex geometries to be created between adjacent blades (other blades not shown). The machined away geometry and cross-section is illustrated in FIG. 1K.

FIGS. 4A to 4D illustrate the welded or deposited joint between the repair patch and the blade.

FIG. 1K illustrates a view of the machined blade incorporating a cross-sectional view of the joint between repair patch and blade after the machining has taken place. As shown the connection between the repair patch and blade is a generally V shaped joint of deposited material following the curved deposition path described above. As also shown the excess deposited material from the deposition process has been machined away, as has the backing portion of the repair patch and abutment stops. A resulting blade with the desired and original aerodynamic performance can therefore be recreated.

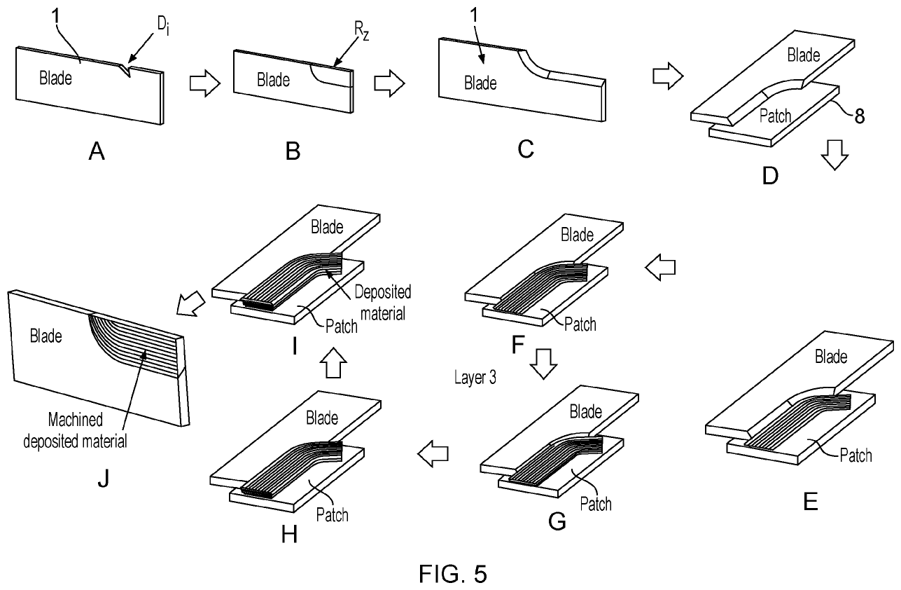

FIGS. 5A to 5J illustrate an alternative repair method according to an invention described herein.

As shown in FIG. 5A a blade 1 includes a discontinuity Di or damaged portion which required repair. As with the example described above a repair zone Rz is determined and machined away using conventional machine techniques. Again the repair zone Rz incorporates a generally curved profile and a tapered shape to create a weld or deposition zone 5 (see FIG. 3). In the example the repair patch is in the form of a substrate 8 optionally having a profile on one side corresponding to the desired aerodynamic profile on the given side of the blade. The substrate may optionally incorporate abutment stops as described above although they are not shown in FIG. 5.

The repair method comprises the steps of bringing the substrate repair patch 8 into contact with the blade to be repaired and then depositing material onto the substrate in a complimentary shape to the repair zone. As with the example described above the substrate has geometries that exceed those of the predetermined repaired blade such that deposition can commence and terminate outside of those geometries. The advantages described above apply equally to this example,

Referring to FIGS. 5E, 5F, 5G and 5H successive deposition is performed to build up the desired material onto the substrate again exceeding the geometry of the predetermined desired shape of blade. FIG. 5I illustrates the resultant component with deposited material extending in excess of the desired geometries of the blade.

The final step is illustrated in FIG. 5J in which the excess material has been machined to create the desired and predetermined blade shape.

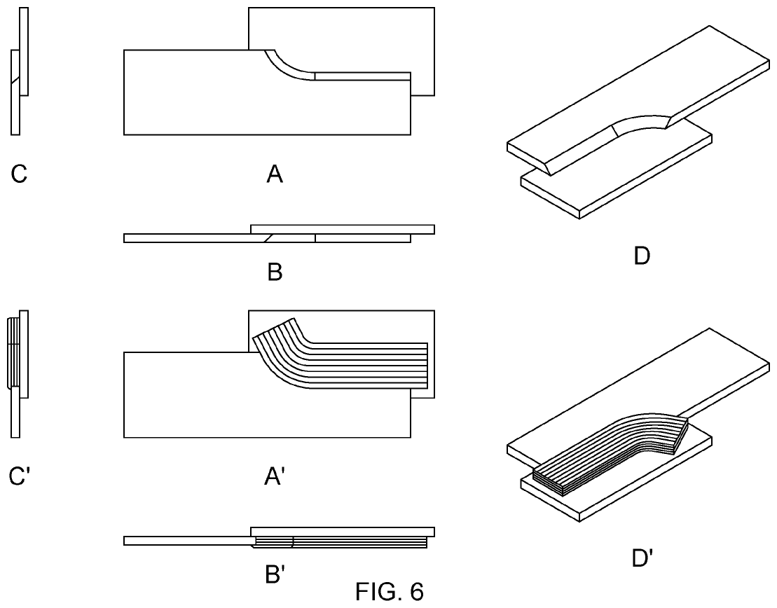

FIGS. 6A to 6D and 6A′ to 6D′ illustrate the second method and substrate patch in plan and cross-section before and after deposition.

Optionally the blade may be heat treated to remove residual stresses caused by the welding process. Heating and cooling the blade or repair patch after welding advantageously allows the temperature history of the part to be controlled and restored to the original characteristics of the blade.

Advantageously cooling may take place during the welding process by applying a coolant or cooling arrangement to the repair patch or plate as welding takes place. Cooling the repair patch or plate during deposition causes the weld to cool down much more quickly and this create a fine microstructure within the weld. More specifically it allows the original microstructure of the blade (which may for example have been forged) to be replicated which enhances the mechanical integrity of the blade and restoration of the blade performance.

Alternatively heat treatment may be applied and the part may be allowed to cool in ambient conditions.

The arrangements and methods described herein provide further advantages in addition to those discussed above with respect to the continuity and quality of the deposited material.

As described herein a blade may be repaired with a sacrificial or partially integrated repair patch. The term partially integrated is intended to refer a repair patch having at least some aspects of the predetermined desired geometry of blade and/or some material that forms part of the repaired blade as opposed to a fully deposited repair.

Advantageously using a patch as described herein conducts energy from the laser beam away from the blade that is being repaired. This means that thermal damage that could be caused by the repair process can be avoided. The heat affected zone can be dramatically reduced and residual stress can be significantly lowered.

The welding may advantageously take place within an environment which does not comprise oxygen. For example an Argon gas flow or argon shroud may be formed around the weld to prevent the creation of alpha phase material within or on the welds. Interaction of oxygen during the welding process undesirably creates alpha phase material which can lead to cracking of titanium material.

The weld beads may themselves be any suitable size. However, a weld bead having a width (W) between 0.1-10 mm and a height (h) between 0.1-10 mm advantageously provides good weld integrity whilst allowing for economical speed in blade repair. A small weld bead also minimises the chances of weld porosity which is undesirable

The inventors have established that both laser powder deposition welding and also laser metal wire deposition can both be used in accordance with inventions described herein. Both additive manufacturing techniques and the operation of such machines will be understood by person skilled in the art of additive manufacture.

1. A method of fan blade repair, the fan blade comprising a repair region and a predetermined repaired geometry, the method comprising the steps of:
aligning a fan blade repair patch against a pre-machined away portion of the fan blade defining a repair perimeter, wherein a portion of the perimeter of the fan blade repair patch has a geometry generally complementary in shape to the repair perimeter of the fan blade so as to define a joining zone between the fan blade and repair patch; and
depositing material by means of direct energy deposition into the joining zone to join the fan blade and repair patch.

2. A method as claimed in claim 1, further comprising the step of machining away a portion of the turbine blade repair patch and excess material to recreate the redetermined geometrical shape of the turbine blade.

3. A method as claimed in claim 1, wherein the step of depositing material by means of direct energy deposition to join the turbine blade and repair patch comprises the steps of (a) forming a weld bead to join the blade and patch together and (b) repeatedly forming subsequent weld beads to fill the joining zone with material.

4. A method as claimed in claim 1, wherein the joining zone is in the form of a generally V-shaped region between the repair patch and repair perimeter of the blade.

5. A method as claimed in claim 1, wherein the repair perimeter of the blade comprises at least one radius of curvature.

6. A method as claimed in claim 1, wherein the turbine blade repair patch has as connecting region and a region corresponding in shape to the original blade.

7. A method as claimed in any preceding claim 1, wherein the turbine blade repair patch is in abutment with one side of the turbine blade and defines a substrate area onto which the material may be deposited.

8. A method as claimed in claim 1 wherein when the turbine repair patch is in abutment with the repair perimeter of the turbine blade at least one of the dimensions of the patch extends beyond the dimension of the desired repaired geometry of the blade.

9. A method as claimed in claim 8, wherein all dimensions of the patch in an x, y and z plane extend beyond the dimension of the desired repaired geometry of the blade and the method comprises the step of machining those dimensions of the joined blade and patch to recreate the predetermined blade geometry.

10. A method as claimed in claim 8, wherein the each deposition step commences and terminates on a portion of the repair patch outside of the dimensions of the predetermined repaired geometry.

11. A method as claimed in claim 1, wherein the step of direct energy deposition is an additive manufacturing process of laser blown material process or laser wire deposition.

12. A method as claimed in claim 1 further comprising the step of machining and optionally acid etching the edges of the repair patch which are to be welded.

13. A method as claimed in any claim 1 further comprising machining away a portion of the fan blade, the portion incorporating the repair region wherein the machined portion defines a repair perimeter of the fan blade.

14. A method as claimed in claim 1, further comprising the step of heat treating the machined and repaired blade.

15. A method as claimed in claim 1, further comprising the step of cooling all or part of the repair patch during the step of material deposition.

16. A method of blown powder laser metal deposition or wire laser metal deposition turbine blade repair, the turbine blade comprising a repair region and a predetermined repaired geometry, the method comprising the steps of:
machining away a portion of the turbine blade, the portion incorporating the repair region wherein the machined portion defines a repair perimeter of the turbine blade;
aligning a turbine blade repair patch against the machined away portion, wherein a portion of the perimeter of the turbine blade repair patch has a geometry generally complementary in shape to the repair perimeter of the turbine blade so as to define a joining zone between the turbine blade and repair patch; and
performing blown powder or wire laser metal deposition within the joining zone to join the turbine blade and repair patch.

17. A method of fan blade repair, the fan blade comprising a repair region and a predetermined repaired geometry, the method comprising the steps of:
aligning a fan blade repair patch against a pre-machined away portion of the fan blade defining a repair perimeter, wherein a portion of the perimeter of the fan blade repair patch has a geometry generally complementary in shape to a portion of the outer geometry of the fan blade to the repair so as to define substrate zone to receive deposited material; and
depositing material by means of direct energy deposition into the substrate zone to join the fan blade and repair patch and recreate a volume of material forming the repaired blade.

18. A fan blade repaired by means of a method as claimed in claim 1.

19. A computer numerically controlled robotic arm comprising a laser metal deposition apparatus configured to perform a method as claimed in claim 1.
